(19) United States
(12) Patent Application Publication
(10) Pub. No.: US 2015/0095017 A1
(43) Pub. Date: Apr. 2, 2015

(54) SYSTEM AND METHOD FOR LEARNING WORD EMBEDDINGS USING NEURAL LANGUAGE MODELS

(71) Applicant: Google Inc., Mountain View, CA (US)

(72) Inventors: Andriy MNIH, London (GB); Koray KAVUKCUOGLU, London (GB)

(21) Appl. No.: 14/075,166

(22) Filed: Nov. 8, 2013

Related U.S. Application Data
(60) Provisional application No. 61/883,620, filed on Sep. 27, 2013.

(51) Int. Cl. G06F 17/27; G06F 17/28

(52) U.S. Cl. CPC G06F 17/276; G06F 17/28; G06F 17/2735
USPC 704/9

(57) ABSTRACT

A system and method are provided for learning natural language word associations using a neural network architecture. A word dictionary comprises words identified from training data consisting a plurality of sequences of associated words. A neural language model is trained using data samples selected from the training data defining positive examples of word associations, and a statistically small number of negative samples defining negative examples of word associations that are generated from each selected data sample. A system and method of predicting a word association is also provided, using a word association matrix including data defining representations of words in a word dictionary derived from a trained neural language model, whereby a word association query is resolved without applying a word position-dependent weighting.

### CROSS-REFERENCE TO RELATED APPLICATIONS

This application is based on, and claims priority to, U.S. Provisional Application No. 61/883,620, filed Sep. 27, 2013, the entire contents of which are fully incorporated herein by reference.

### FIELD OF THE INVENTION

This invention relates to a natural language processing and information retrieval system, and more particularly to an improved system and method to enable efficient representation and retrieval of word embeddings based on a neural language model.

### BACKGROUND OF THE INVENTION

Natural language processing and information retrieval systems based on neural language models are generally known, in which real-valued representations of words are learned by neural probabilistic language models (NPLMs) from large collections of unstructured text. NPLMs are trained to learn word embedding (similarity) information and associations between words in a phrase, typically to solve the classic task of predicting the next word in sequence given an input query phrase. Examples of such word representations and NPLMs are discussed in “A unified architecture for natural language processing: Deep neural networks with multitask learning”—Collobert and Weston (2008), “Parsing natural scenes and natural language with recursive neural networks”—Socher et al. (2011), “Word representations: A simple and general method for semi-supervised learning”—Turian et al. (2010).

When scaling up NLPMs to handle large vocabularies and solving the above classic task of predicting the next word in sequence, known techniques typically consider the relative word positions within the training phrases and the query phrases to provide accurate prediction query resolution. One approach is to learn conditional word embeddings using a hierarchical or tree-structured representation of the word space, as discussed for example in “Hierarchical probabilistic neural network language model”—Morin and Bengio (2005) and “A scalable hierarchical distributed language model”—Mnih and Hinton (2009). Another common approach is to compute normalized probabilities, applying word position-dependent weightings, as discussed for example in “A fast and simple algorithm for training neural probabilistic language models”—Mnih and The (2012), “Three new graphical models for statistical language modeling”—Mnih and Hinton (2009), and “Improving word representations via global context and multiple word prototypes”—Huang et al (2012). Consequently, training of known neural probabilistic language models is computationally demanding. Application of the trained NPLMs to predict a next word in sequence also requires significant processing resource.

Natural language processing and information retrieval systems are also known from patent literature. WO2008/109665, U.S. Pat. No. 6,189,002 and U.S. Pat. No. 7,426,506 discuss examples of such systems for semantic extraction using neural network architecture.

What is desired is a more robust neural probabilistic language model for representing word associations that can be trained and applied more efficiently, particularly to the problem of resolving analogy-based, unconditional, word similarity queries.

### STATEMENTS OF THE INVENTION

Aspects of the present invention are set out in the accompanying claims.

According to one aspect of the present invention, a system and computer-implemented method are provided of learning natural language word associations, embeddings, and/or similarities, using a neural network architecture, comprising storing data defining a word dictionary comprising words identified from training data consisting a plurality of sequences of associated words, selecting a predefined number of data samples from the training data, the selected data samples defining positive examples of word associations, generating a predefined number of negative samples for each selected data sample, the negative samples defining negative examples of word associations, wherein the number of negative samples generated for each data sample is a statistically small proportion of the number of words in the word dictionary, and training a neural probabilistic language model using the data samples and the generated negative samples.

The negative samples for each selected data sample may be generated by replacing one or more words in the data sample with a respective one or more replacement words selected from the word dictionary. The one or more replacement words may be pseudo-randomly selected from the word dictionary based on frequency of occurrence of words in the training data.

Preferably, the number of negative samples generated for each data sample is between 1/10000 and 1/100000 of the number of words in the word dictionary.

The neural probabilistic language model may output a word representation for an input word, representative of the association between the input word and other words in the word dictionary. A word association matrix may be generated, comprising a plurality of vectors, each vector defining a representation of a word in the word dictionary output by the trained neural language model. The word association matrix may be used to resolve a word association query. The query may be resolved without applying a word position-dependent weighting.

Preferably, training the neural language model does not apply a word position-dependent weighting. The training samples may each include a target word and a plurality of context words that are associated with the target word, and label data identifying the sample as a positive example of word association. The negative samples may each include a target word and a plurality of context words that are selected from the word dictionary, and label data identifying the sample as a negative example of word association.

The neural language model may be configured to receive a representation of the target word and representations of the plurality of context words of an input sample, and to output a probability value indicative of the likelihood that the target word is associated with the context words. Alternatively, the neural language model may be configured to receive a representation of the target word and representations of at least one context word of an input sample, and to output a probability value indicative of the likelihood that at least one context word is associated with the target word. Training the neural language model may comprise adjusting parameters based on a calculated error value derived from the output probability value and the label associated with the sample.

The word dictionary may be generated based on the training data, wherein the word dictionary includes calculated values of the frequency of occurrence of each word within the training data. The training data may be normalized. Preferably, the training data comprises a plurality of sequences of associated words.

In another aspect, the present invention provides a system and method of predicting a word association between words in a word dictionary, comprising processor implemented steps of storing data defining a word association matrix including a plurality of vectors, each vector defining a representation of a word derived from a trained neural probabilistic language model, receiving a plurality of query words, retrieving the associated representations of the query words from the word association matrix, calculating a candidate representation based on the retrieved representations, and determining at least one word in the word dictionary that matches the candidate representation, wherein the determination is made based on the word association matrix and without applying a word position-dependent weighting.

The candidate representation may be calculated as the average representation of the retrieved representations. Alternatively, calculating the representation may comprise subtracting one or more retrieved representations from one or more other retrieved representations.

One or more query words may be excluded from the word dictionary before calculating the candidate representation. Each word representation may be representative of the association or similarity between the input word and other words in the word dictionary.

In other aspects, there are provided computer programs arranged to carry out the above methods when executed by suitable programmable devices.

### BRIEF DESCRIPTION OF THE DRAWINGS

There now follows, by way of example only, a detailed description of embodiments of the present invention, with references to the figures identified below.

FIG. 1 is a block diagram showing the main components of a natural language processing system according to an embodiment of the invention.

FIG. 2 is a block diagram showing the main components of a training engine of the natural language processing system in FIG. 1, according to an embodiment of the invention.

FIG. 3 is a block diagram showing the main components of a query engine of the natural language processing system in FIG. 1, according to an embodiment of the invention.

FIG. 4 is a flow diagram illustrating the main processing steps performed by the training engine of FIG. 2 according to an embodiment.

FIG. 5 is a schematic illustration of an example neural language model being trained on an example input training sample.

FIG. 6 is a flow diagram illustrating the main processing steps performed by the query engine of FIG. 3 according to an embodiment.

FIG. 7 is a schematic illustration of an example analogy-based word similarity query being processed according to the present embodiment.

FIG. 8 is a diagram of an example of a computer system on which one or more of the functions of the embodiment may be implemented.

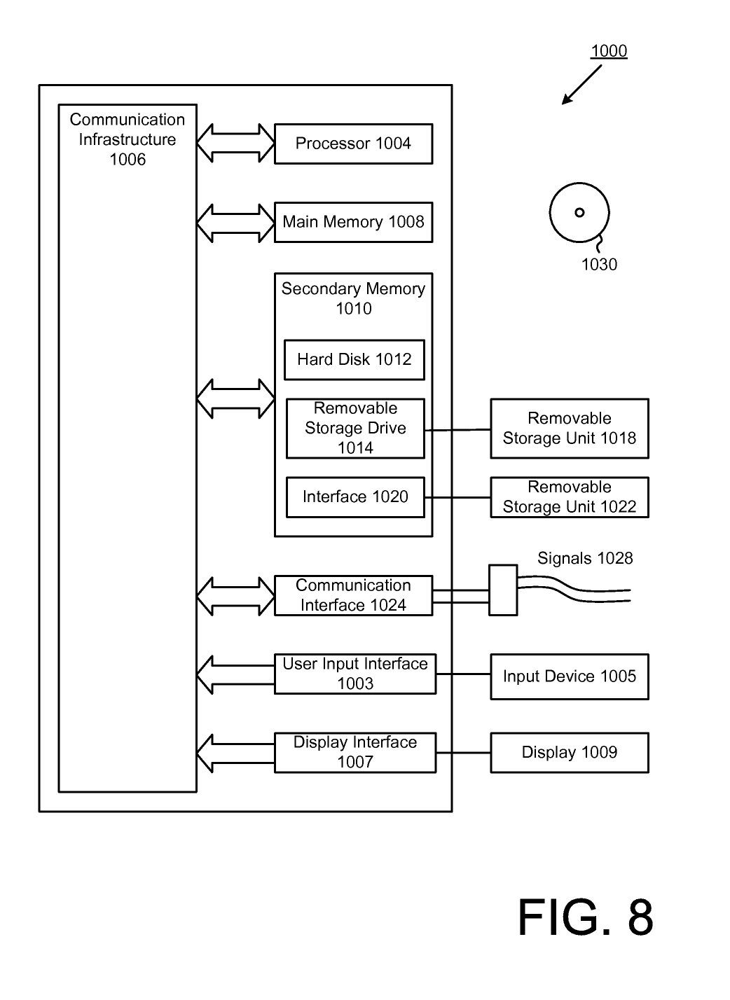

### DETAILED DESCRIPTION OF EMBODIMENTS OF THE INVENTION

### Overview

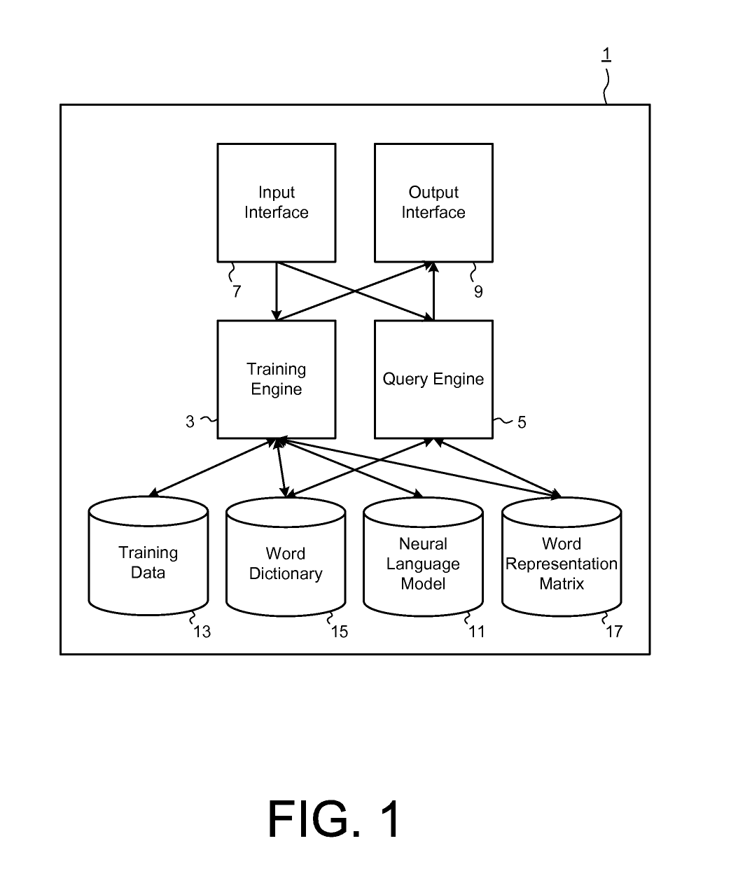

A specific embodiment of the invention will now be described for a process of training and utilizing a word embedding neural probabilistic language model. Referring to FIG. 1, a natural language processing system 1 according to an embodiment comprises a training engine 3 and a query engine 5, each coupled to an input interface 7 for receiving user input via one or more input devices (not shown), such as a mouse, a keyboard, a touch screen, a microphone, etc. The training engine 3 and query engine 5 are also coupled to an output interface 9 for outputting data to one or more output devices (not shown), such as a display, a speaker, a printer, etc.

The training engine 3 is configured to learn parameters defining a neural probabilistic language model 11 based on natural language training data 13, such as a word corpus consisting of a very large sample of word sequences, typically natural language phrases and sentences. The trained neural language model 11 can be used to generate a word representation vector, representing the learned associations between an input word and all other words in the training data 13. The trained neural language model 11 can also be used to determine a probability of association between an input target word and a plurality of context words. For example, the context words may be the two words preceding the target word and the two words following the target word, in a sequence consisting five natural language words. Any number and arrangement of context words may be provided for a particular target word in a sequence.

The training engine 3 may be configured to build a word dictionary 15 from the training data 13, for example by parsing the training data 13 to generate and store a list of unique words with associated unique identifiers and calculated frequency of occurrence within the training data 13. Preferably, the training data 13 is pre-processed to normalize the sequences of natural language words that occur in the source word corpus, for example to remove punctuation, abbreviations, etc., while retaining the relative order of the normalized words in the training data 13. The training engine 3 is also configured to generate and store a word representation matrix 17 comprising a plurality of vectors, each vector defining a representation of a word in the word dictionary 15 derived from the trained neural language model 11.

As will be described in more detail below, the training engine 3 is configured to apply a noise contrastive estimation technique to the process of training the neural language model 11, whereby the model is trained using positive samples from the training data defining positive examples of word associations, as well as a predetermined number of generated negative samples (noise samples) defining negative examples of word associations. A predetermined number of negative samples are generated from each positive sample. In one embodiment, each positive sample is modified to generate a plurality of negative samples, by replacing one or more words in the positive sample with a pseudo-randomly selected word from the word dictionary 15. The replacement word may be pseudo-randomly selected, for example based on the stored associated frequencies of occurrences.

The query engine 5 is configured to receive input of a plurality of query words, for example via the input interface 7, and to resolve the query by determining one or more words that are determined to be associated with the query words. The query engine 5 identifies one or more associated words from the word dictionary 15 based on a calculated average of the representations of each query word retrieved from the word representation matrix 17. In this embodiment, the determination is made without applying a word position-dependent weighting to the scoring of the words or representations, as the inventors have realized that such additional computational overheads are not required to resolve queries for predicted words associations, as opposed to prediction of the next word in a sequence. Advantageously, word association query resolution by the query engine 5 of the present embodiment is computationally more efficient.

### Training Engine

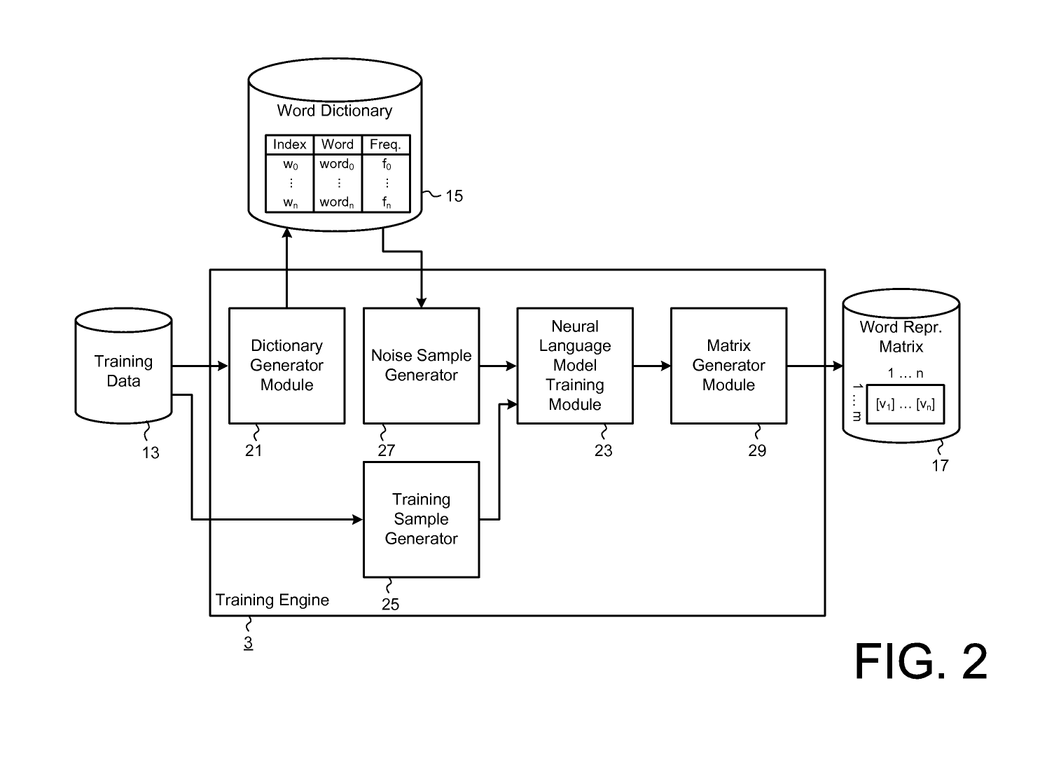

The training engine 3 in the natural language processing system 1 will now be described in more detail with reference to FIG. 2. As shown, the training engine 3 includes a dictionary generator module 21 for populating an indexed list of words in the word dictionary 15 based on identified words in the training data 13. The unique index values may be of any form that can be presented in a binary representation, such as numerical, alphabetic, or alphanumeric symbols, etc. The dictionary generator module 21 is also configured to calculate and update the frequency of occurrence for each identified word, and to store the frequency data values in the word dictionary 15. The dictionary generator module 21 may be configured to normalize the training data 13 as mentioned above.

The training engine 3 also includes a neural language model training module 23 that receives positive data samples derived from the training data 13 by a positive sample generator module 25, and negative data samples generated from each positive data sample by a negative sample generator module 27. The negative sample generator module 27 receives each positive sample generated by the positive sample generator module 25 and generates a predetermined number of negative samples based on the received positive sample. In this embodiment, the negative sample generator module 27 modifies each received positive sample to generate a plurality of negative samples by replacing a word in the positive sample with a pseudo-randomly selected word from the word dictionary 15 based on the stored associated frequencies of occurrences, such that words that appear more frequently in the training data 13 are selected more frequently for inclusion in the generated negative samples. For example, the middle word in the sequence of words in the positive sample can be replaced by a pseudo-randomly selected word from the word dictionary 15 to derive a new negative sample. In this way, the base positive sample and the derived negative samples include the same predefined number of words and differ by one word.

The training samples are associated with a positive label, indicative of a positive example of association between a target word and the surrounding context words in the sample. On the contrary, the negative samples are associated with a negative label, indicative of a negative example of word association because of the pseudo-random fabrication of the sample. As mentioned above, the associations, embeddings and/or similarities between words are modeled by parameters (commonly referred to as weights) of the neural language model 11. The neural language model training module 23 is configured to learn the parameters defining the neural language model based on the training samples and the negative samples, by recursively adjusting the parameters based on the calculated error or discrepancy between the predicted probability of word association of the input sample output by the model compared to the actual label of the sample.

The training engine 3 includes a word representation matrix generator module 29 that determines and updates the word representation vector stored in the word representation matrix 17 for each word in the word dictionary 15. The word representation vector values correspond to the respective values of the word representation that are output from a group of nodes in the hidden layer.

### Query Engine

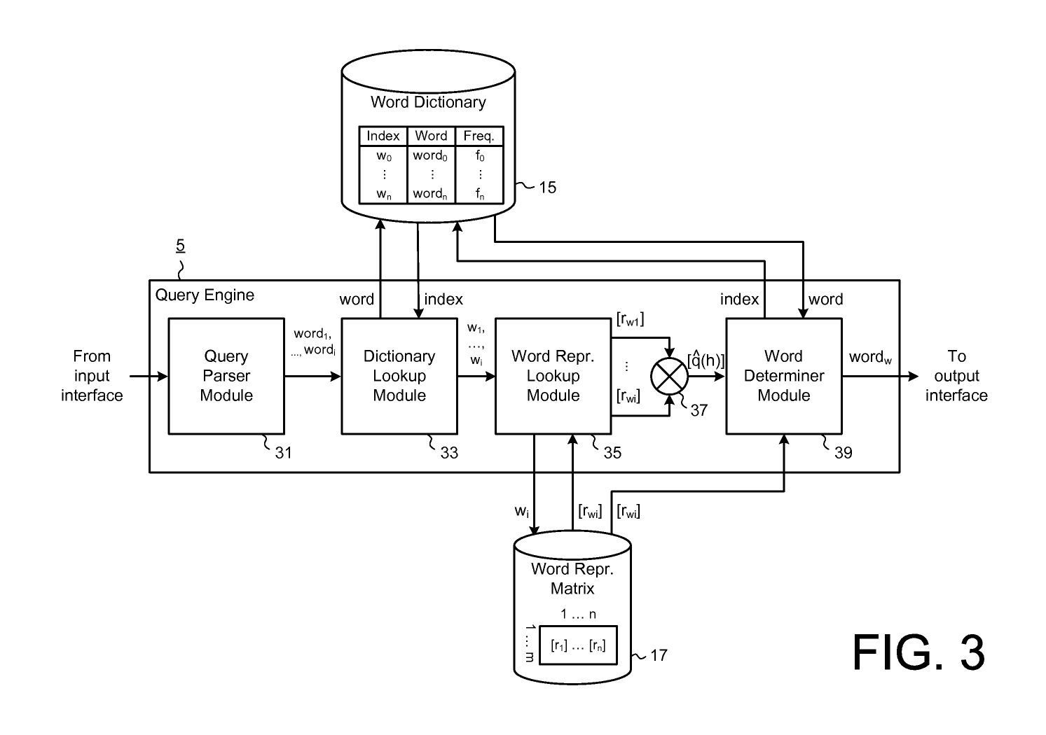

The query engine 5 in the natural language processing system 1 will now be described in more detail with reference to FIG. 3. As shown, the query engine 3 includes a query parser module 31 that receives an input query, for example from the input interface 7. In the example illustrated in FIG. 3, the input query includes two query words (womb, word₂), where the user is seeking a target word that is associated with both query words.

A dictionary lookup module 33, communicatively coupled to the query parser module 31, receives the query words and identifies the respective indices (w₂, w₂) from a lookup of the index values stored in the word dictionary 15. The identified indices for the query words are passed to a word representation lookup module 35, coupled to the dictionary lookup module 33, that retrieves the respective word representation vectors (v₁, v₂) from the word representation matrix 17. The retrieved word representation vectors are combined at a combining node 37 (or module), coupled to the word representation lookup module 35, to derive an averaged word representation vector (\hat{ν}₃), that is representative of a candidate word associated with both query words.

A word determiner module 39, coupled to the combining node 37, receives the averaged word representation vector and determines one or more candidate matching words based on the word representation matrix 17 and the word dictionary 15. In this embodiment, the word determiner module 39 is configured to compute a ranked list of candidate matching word representations by performing a dot product of the average word representation vector and the word representation matrix. In this way, the processing does not involve application of any position-dependent weights to the word representations. The corresponding word for a matching vector can be retrieved from the word dictionary 15 based on the vector's index in the matrix 17. The candidate word or words for the resolved query may be output by the word determiner module 39, for example to the output interface 9 for output to the user.

### Neural Language Model Training Process

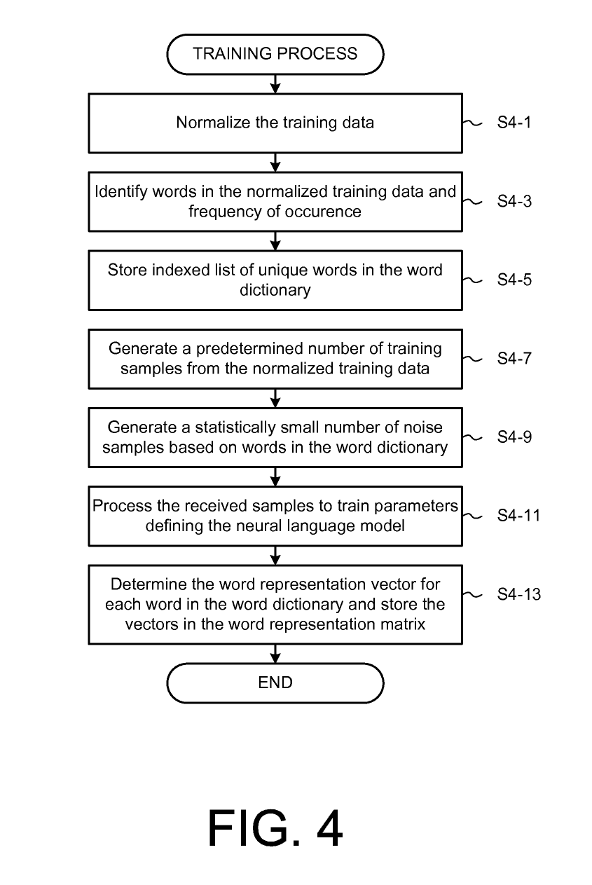

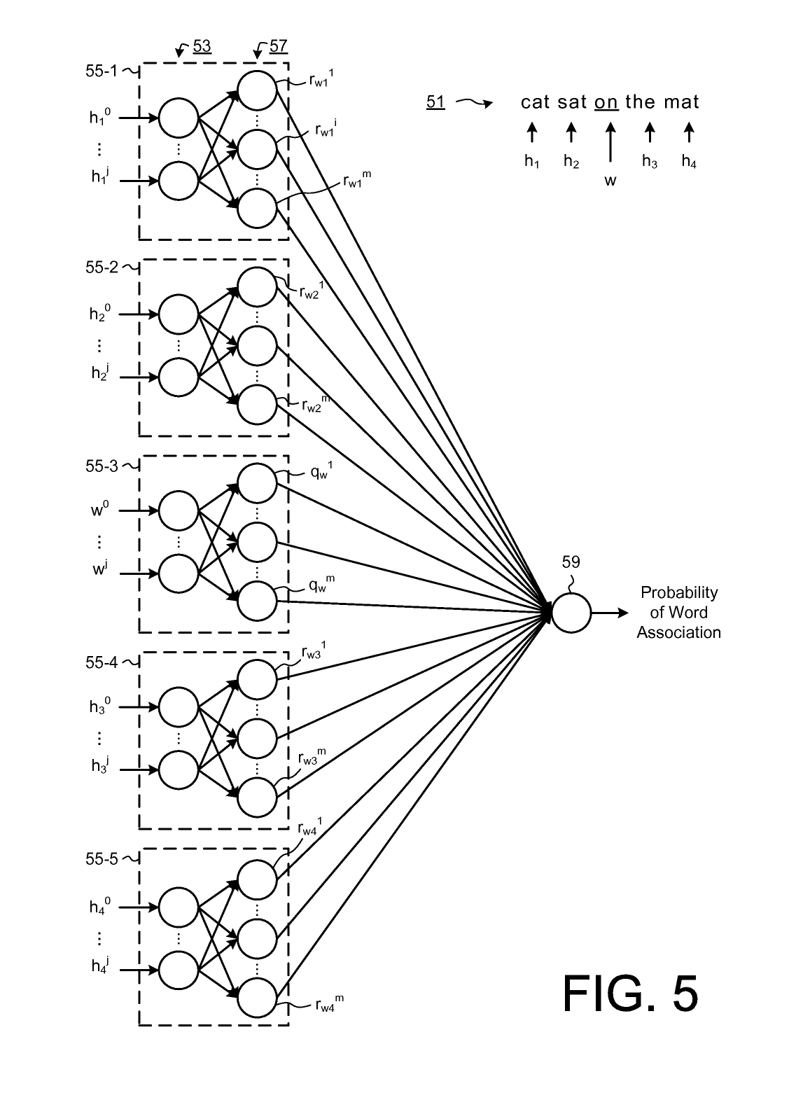

A brief description has been given above of the components forming part of the natural language processing system 1 of the present embodiments. A more detailed description of the operation of these components will now be given with reference to the flow diagrams of FIG. 4, for an exemplary embodiment of the computer-implemented training process using the training engine 3. Reference is also made to FIG. 5, schematically illustrating an exemplary neural language model being trained on an example input training sample.

As shown in FIG. 4, the process begins at step S4-1 where the dictionary generator module 21 processes the natural language training data 13 to normalize the sequences of words in the training data 13, for example to remove punctuation, abbreviations, formatting, XML headers, mapping all words to lowercase, replacing all numerical digits, etc. At step S4-3, the dictionary generator module 21 identifies unique words of the normalized training data 13, together with a count of the frequency of occurrence for each identified word in the list. Preferably, an identified word may be classified as a unique word only if the word occurs at least a predefined number of times (e.g. five or ten times) in the training data.

At step S4-5, the identified words and respective frequency values are stored as an indexed list of unique words in the word dictionary 15. In this embodiment, the index is an integer value, from one to the number of unique words identified in the normalized training data 13. For example, two suitable freely-available datasets are the English Wikipedia data set with approximately 1.5 billion words, from which a word dictionary 15 of 800,000 unique normalized words can be determined, and the collection of Project Gutenberg texts with approximately 47 million words, from which a word dictionary 15 of 80,000 unique normalized words can be determined.

At step S4-7, the training sample generator module 25 generates a predetermined number of training samples by randomly selecting sequences of words from the normalized training data 13. Each training sample is associated with a data label indicating that the training sample is a positive example of the associations between a target word and the surrounding context words in the training sample.

Probabilistic neural language models specify the distribution for the target word w, given a sequence of words h, called the context. Typically, in statistical language modeling, w is the next word in the sentence, while the context h is the sequence of words that precede w. In the present embodiment, the training process is interested in learning word representations as opposed to assigning probabilities to sentences, and therefore the models are not restricted to predicting the next word in sequence. Instead, the training process is configured in one embodiment to learn the parameters for a neural probabilistic language model by predicting the target word w from the words surrounding it. This model will be referred to as a vector log-bilinear language model (vLBL). Alternatively, the training process can be configured to predict the context word(s) from the target word, for an NPLM according to another embodiment. This alternative model will be referred to as an inverse vLBL (ivLBL).

Referring to FIG. 5, an example training sample 51 is the phrase “cat sat on the mat”, consisting of five words occurring in sequence in the normalized training data 13. The target word w in this sample is “on” and the associated context consists the two words h₁, h₂ preceding the target, and the two words h₃, h₄ succeeding the target. It will be appreciated that the training samples may include any number of words. The context can consist of words preceding, following, or surrounding the word being predicted. Given the context h, the NPLM defines the distribution for the word to be predicted using the scoring function s_{θ}(w, h) that quantifies the compatibility between the context and the candidate target word. Here θ are model parameters, which include the word embeddings. Generally, the scores are converted to probabilities by exponentiating and normalizing:

$${P}_{θ}^{h} ( w ) = \frac{exp ( {s}_{θ} ( w , h ) )}{{\sum }_{{w}^{′}} exp ( {s}_{θ} ( {w}^{′} , h ) )} \qquad ( 1 )$$

In one embodiment, the vLBL model has two sets of word representations: one for the target words (i.e. the words being predicted) and one for the context words. The target and the context representations for word w are denoted with q_{w} and r_{w} respectively. Given a sequence of context words h=w₁; . . . ; wₙ, conventional models may compute the predicted representation for the target word by taking a linear combination of the context word feature vectors:

$$\hat{q} ( h ) = {\sum }_{i = 1}^{n} {c}_{i} ⊗ {r}_{{w}_{i}} \qquad ( 2 )$$

where cᵢ is the weight vector for the context word in position i and \textcircled{x} denotes element-wise multiplication.

The scoring function then computes the similarity between the predicted feature vector and one for word w:

s_{θ}(w,h)=\hat{q}(h)^{T}q_{w}_{ᵢ}+b_{w}_{ᵢ} (3)

where b_{w}_{ᵢ} is an optional bias that captures the context-independent frequency of word w. In this embodiment, the conventional scoring function from Equations 2 and 3 is adapted to eliminate the position-dependent weights and computing the predicted feature vector \hat{q}(h) simply by averaging the context feature word vectors r_{w}_{ᵢ}:

$$\hat{q} ( h ) = \frac{1}{n} {\sum }_{i = 1}^{n} {r}_{{w}_{i}} \qquad ( 4 )$$

The result is something like a local topic model, which ignores the order of context words, potentially forcing it to capture more semantic information, possibly at the expense of syntax.

In the alternative embodiment, the ivLBL model is used to predict the context from the target word, based on an assumption that the words in different context positions are conditionally independent given the current word w:

$${P}_{θ}^{h} ( w ) = {\prod }_{i = 1}^{n} {P}_{i , θ}^{w} ( {w}_{i} ) \qquad ( 5 )$$

The context word distributions P_{i,θ}^{w}(wᵢ) are simply vLBL models that condition on the current word w and are defined by the scoring function:

s_{i,θ}(wᵢ,w)=(cᵢ [symbol] r_{w})^{T}q_{w}_{ᵢ}+b_{w}_{ᵢ} (6)

The resulting model can be seen as a Naïve Bayes classifier parameterized in terms of word embeddings.

The scoring function in this alternative embodiment is thus adapted to compute the similarity between the predicted feature vector r_{w} for a context word w, and the vector representation q for word wᵢ, without position-dependent weights:

s_{i,θ}(wᵢ,w)=r_{w}^{T}q_{w}_{ᵢ}+b_{w}_{ᵢ} (7)

where b_{w}_{ᵢ} is the optional bias that captures the context-independent frequency of word wᵢ.

In this way, the present embodiments provide an efficient technique of training a neural probabilistic language model by learning to predict the context from the word, or learning to predict a target word from its context. These approaches are based on the principle that words with similar meanings often occur in the same contexts and thus the NPLM training process of the present embodiments efficiently look for word representations that capture their context distributions.

In the present embodiments, the training process is further adapted to use noise-contrastive estimation (NCE) to train the neural probabilistic language model. NCE is based on the reduction of density estimation to probabilistic binary classification. Thus a logistic regression classifier can be trained to discriminate between samples from the data distribution and samples from some “noise” distribution, based on the ratio of probabilities of the sample under the model and the noise distribution. The main advantage of NCE is that it allows the present technique to fit models that are not explicitly normalized making the training time effectively independent of the vocabulary size. Thus, the normalizing factor may be dropped from Equation 1 above, and exp(s_{θ}(w, h)) may simply be used in place of P_{θ}^{h}(w) during training. The perplexity of NPLMs trained using this approach has been shown to be on par with those trained with maximum likelihood learning, but at a fraction of the computational cost.

Accordingly, at step S4-9, the negative sample generator module 27 receives each positive sample generated by the positive sample generator module 25 and generates a predetermined number of negative samples based on the received positive sample, by replacing a target word in the sequence of words in the positive sample with a pseudo-randomly selected word from the word dictionary 15 to derive a new negative sample. Advantageously, the number of negative samples that is generated for each positive sample is predetermined as a statistically small proportion of the total number of words in the word dictionary 15. For example, accurate results are achieved using a small, fixed number of noise samples generated from each positive sample, such as 5 or 10 negative samples per positive sample, which may be in the order of 1/10,000 to 1/100,000 of the number of unique normalized words in the word dictionary 15 (e.g. 80,000 or 800,000 as mentioned above). Each negative sample is associated with a negative data label, indicative of a negative example of word association between the pseudo-randomly selected replacement target word and the surrounding context words in the negative sample. Preferably, the positive and negative samples have fixed-length contexts.

The NCE-based training technique can make use of any noise distribution that is easy to sample from and compute probabilities under, and that does not assign zero probability to any word. For example, the (global) unigram distribution of the training data can be used as the noise distribution, a choice that is known to work well for training language models. Assuming that negative samples are k times more frequent than data samples, the probability that the given sample came from the data is

$${P}^{h} ( D = 1 \vert w ) = \frac{{P}_{d}^{h} ( w )}{{P}_{d}^{h} ( w ) + {kP}_{n} ( w )} \qquad ( 8 )$$

In the present embodiment, this probability is obtained by using the trained model distribution in place of P_{d}^{h}:

$${P}^{h} ( D = 1 \vert w , θ ) = \frac{{P}_{θ}^{h} ( w )}{{P}_{θ}^{h} ( w ) + {kP}_{n} ( w )} = σ ( Δ {s}_{θ} ( w , h ) ) \qquad ( 6 )$$

where σ(x) is the logistic function and Δs_{θ}(w,h)=s_{θ}(w,h)−log(kPₙ(w)) is the difference in the scores of word w under the model and the (scaled) noise distribution. The scaling factor k in front of Pₙ(w) accounts for the fact that negative samples are k times more frequent than data samples.

Note that in the above equation, s_{θ}(w,h) is used in place of log P_{θ}^{h}(w), ignoring the normalization term, because the technique uses an unnormalized model. This is possible because the NCE objective encourages the model to be approximately normalized and recovers a perfectly normalized model if the model class contains the data distribution. The model can be fitted by maximizing the log-posterior probability of the correct labels D averaged over the data and negative samples:

$$\begin{matrix}{J}^{h} ( θ ) = {E}_{{P}_{d}^{h}} [ log {P}^{h} ( D = 1 \vert w , θ ) ] + {kE}_{{P}_{n}} [ log {P}^{h} ( D = 0 \vert w , θ ) ] \\ = {E}_{{P}_{d}^{h}} [ log σ ( {Δs}_{θ} ( w , h ) ) ] + {kE}_{{P}_{n}} [ log ( 1 - σ ( {Δs}_{θ} ( w , h ) ) ) ]\end{matrix} \qquad ( 9 )$$

In practice, the expectation over the noise distribution is approximated by sampling. Thus, the contribution of a word/context pair w; h to the gradient of Equation 7 can be estimated by generating k negative samples {xᵢ} and computing:

$$\frac{\partial }{\partial θ} {J}^{h , w} ( θ ) = ( 1 - σ ( {Δs}_{θ} ( w , h ) ) ) \frac{\partial }{\partial θ} log {P}_{θ}^{h} ( w ) - {\sum }_{i = 1}^{k} [ σ ( {Δs}_{θ} ( {x}_{i} , h ) ) \frac{\partial }{\partial θ} log {P}_{θ}^{h} ( {x}_{i} ) ] \qquad ( 10 )$$

Note that the gradient in Equation 8 involves a sum over k negative samples instead of a sum over the entire vocabulary, making the NCE training time linear in the number of negative samples and independent of the vocabulary size. As the number of negative samples k is increased, this estimate approaches the likelihood gradient of the normalized model, allowing a trade off between computation cost and estimation accuracy.

Returning to FIG. 4, at step S4-11, the neural language model training module 23 receives the generated training samples and the generated negative samples, and processes the samples in turn to train parameters defining the neural language model. In the example illustrated in FIG. 5, a schematic illustration is provided for a vLBL NPLM according to an exemplary embodiment, being trained on one example training data sample. The neural language model in this example includes:
an input layer 53, comprising a plurality of groups 55 of input layer nodes, each group 55 of nodes receiving respective values of the representation of an input word (target word, w⁰ . . . w^{j}, and context words, hₙ⁰ . . . hₙ^{j} of the sample, where j is the number of elements in the word vector representation);
a hidden layer 57, also comprising a plurality of groups 55 of hidden layer nodes, each group 55 of nodes in the hidden layer being coupled to the nodes of the respective group of nodes in the input layer 53, and outputting values of a word representation for the respective input word of the sample (target word representation, q_{w}⁰ . . . q_{w}^{m}, and context word representations, r_{wn}⁰ . . . r_{wn}^{m}, where m is a predefined number of nodes for the hidden layer); and
an output node 59 coupled to the plurality of nodes of the hidden layer 57, and outputting a calculated probability value indicative of the likelihood that the input target word is associated with the input context words of the sample, for example based on the scoring function of Equation 4 above.

Each connection between respective nodes in the model can be associated with a parameter (weight). The neural language model training module 23 recursively adjusts the parameters based on the calculated error or discrepancy between the predicted probability of word association of the input sample output by the model compared to the actual label of the sample. Such recursive training of model parameters of NPLMs is of a type that is known per se, and need not be described further.

At step S4-13, the word representation matrix generator module 29 determines the word representation vector for each word in the word dictionary 15 and stores the vectors as respective columns of data in a word representation matrix 17, indexed according to the associated index value of the word in the word dictionary 15. The word representation vector values correspond to the respective values of the word representation that are output from a group of nodes in the hidden layer.

### Word Association Query Resolution Process

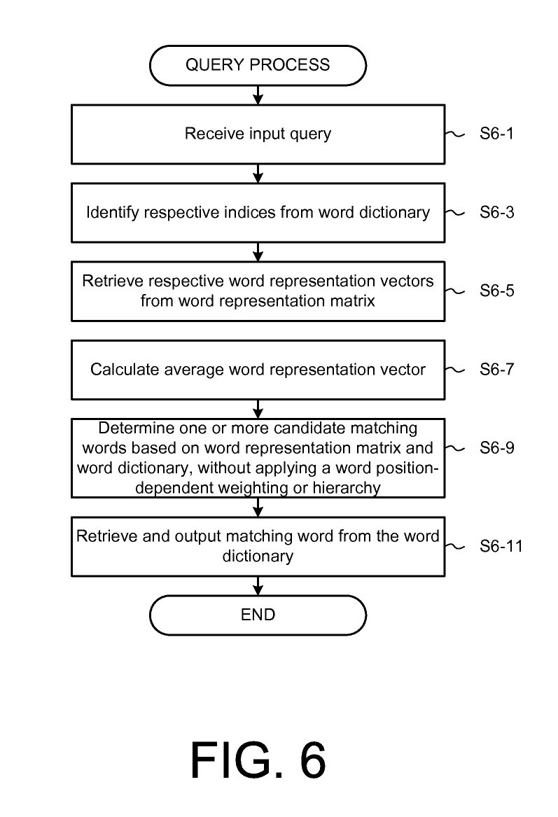

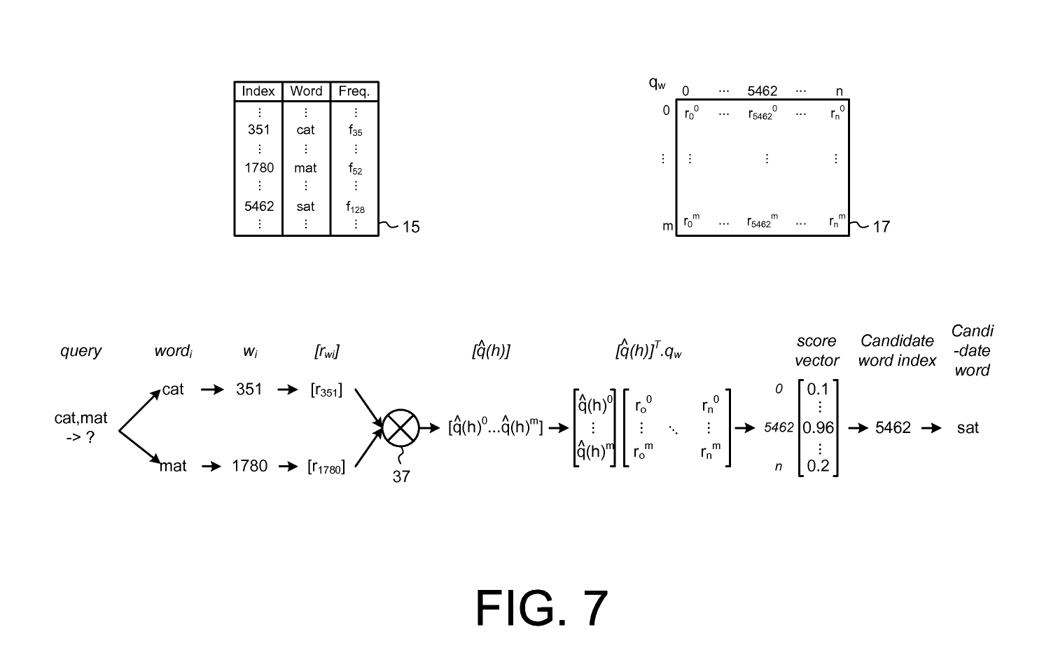

A brief description has been given above of the components forming part of the natural language processing system 1 of the present embodiments. A more detailed description of the operation of these components will now be given with reference to the flow diagrams of FIG. 6, for an exemplary embodiment of the computer-implemented query resolution process using the query engine 5. Reference is also made to FIG. 7, schematically illustrating an example of an analogy-based word similarity query being processed according to the present embodiment.

As shown in FIG. 6, the process begins at step S6-1 where the query parser module 31 receives an input query from the input interface 7, identifying two or more query words, where the user is seeking a target word that is associated with all of the input query words. For example, FIG. 7 illustrates an example query consisting of two input query words: “cat” (word₁) and “mat” (word₂). At step S6-3, the dictionary lookup module 33 identifies the respective indices 351 for “cat” (w₁) and 1780 (w₂) for “mat”, from a lookup of the index values stored in the word dictionary 15. At step S6-5, the word representation lookup module 35 receives the identified indices (w₁, w₂) for the query words and retrieves the respective word representation vectors r₃₅₁ for “cat” and r₁₇₈₀ for “mat” (r_{w1}, r_{w2}) from the word representation matrix 17.

At step S6-7, the combining node 37 calculates the average word representation vector \hat{q}(h) of the retrieved word representation vectors (r_{w1}, r_{w2}), representative of a candidate word associated with both query words. As discussed above, the present embodiment eliminates the use of position-dependent weights and computes the predicted feature vector simply by averaging the context word feature vectors, which ignores the order of context words.

At step S6-9, the word determiner module 39 receives the averaged word representation vector and determines one or more candidate matching words based on the word representation matrix 17 and the word dictionary 15. In this embodiment, the word determiner module 39 is configured to compute a ranked list of candidate matching word representations by performing a dot product of the average word representation vector \hat{q}(h) and the word representation matrix q_{w}, without applying a word position-dependent weighting.

From the resulting vector of probability scores, the corresponding word or words for one or more best-matching vectors, e.g. the highest score, can be retrieved from the word dictionary 15 based on the vector's index in the matrix 17. In the example illustrated in FIG. 7, score vector index 5462 has the highest probability score of 0.25, corresponding to the word “sat” in the word dictionary 15. At step S6-11, the candidate word or words for the resolved query are output by the word determiner module 39 to the output interface 9 for output to the user.

Those skilled in the art will appreciate that the above query resolution technique can be adapted and applied to other forms of analogy-based challenge sets, such as queries that consist of questions of the form “a is to b is as c is to _{——}”, denoted as a:b→c:?. In such an example, the task is to identify the held-out fourth word, with only exact word matches deemed correct. Word embeddings learned by neural language models have been shown to perform very well on these datasets when using the following vector-similarity-based protocol for answering the questions. Suppose \vec{w} is the representation vector for word w normalized to unit norm. Then, the query a:b→c:? can be resolved by a modified embodiment, by finding the word d* with the representation closest to \vec{b}−\vec{a}+\vec{c} according to cosine similarity:

$${d}^{*} = {arg max}_{x} \frac{{( {b}^{->} - {a}^{->} + {c}^{->} )}^{T} x}{\vert \vert {b}^{->} - {a}^{->} + {c}^{->} \vert \vert} \qquad ( 11 )$$

The inventors have realized that the present technique can be further adapted to exclude b and c from the vocabulary when looking for d* using Equation 11, in order to achieve more accurate results. To see why this is necessary, Equation 11 can be rewritten as

$${d}^{*} = {arg max}_{x} {{b}^{->}}^{T} {x}^{->} - {{a}^{->}}^{T} {x}^{->} + {{c}^{->}}^{T} {x}^{->} \qquad ( 12 )$$

where it can be seen that setting x to b or c maximizes the first or third term respectively (since the vectors are normalized), resulting in a high similarity score. This equation suggests the following interpretation of d*: it is simply the word with the representation most similar to \vec{b} and \vec{c} and dissimilar to \vec{a}, which makes it quite natural to exclude b and c themselves from consideration.

### Computer Systems

The entities described herein, such as the natural language processing system 1 or the individual training engine 3 and query engine 5, may be implemented by computer systems such as computer system 1000 as shown in FIG. 7, shown by way of example. Embodiments of the present invention may be implemented as programmable code for execution by such computer systems 1000. After reading this description, it will become apparent to a person skilled in the art how to implement the invention using other computer systems and/or computer architectures, including mobile systems and architectures, and the like.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network).

Computer system 1000 also includes a user input interface 1003 connected to one or more input device(s) 1005 and a display interface 1007 connected to one or more display(s) 1009. Input devices 1005 may include, for example, a pointing device such as a mouse or touchpad, a keyboard, a touch screen such as a resistive or capacitive touch screen, etc.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fiber optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

Alternative embodiments may be implemented as control logic in hardware, firmware, or software or any combination thereof.

### Alternative Embodiments

It will be understood that embodiments of the present invention are described herein by way of example only, and that various changes and modifications may be made without departing from the scope of the invention.

For example, in the embodiments described above, the natural language processing system includes both a training engine and a query engine. As the skilled person will appreciate, the training engine and the query engine may instead be provided as separate systems, sharing access the respective data stores. The separate systems may be in networked communication with one another, and/or with the data stores.

In the embodiment described above, the mobile device stores a plurality of application modules (also referred to as computer programs or software) in memory, which when executed, enable the mobile device to implement embodiments of the present invention as discussed herein. As those skilled in the art will appreciate, the software may be stored in a computer program product and loaded into the mobile device using any known instrument, such as removable storage disk or drive, hard disk drive, or communication interface, to provide some examples.

As a further alternative, those skilled in the art will appreciate that the hierarchical processing of words or representations themselves, as is known in the art, can be included in the query resolution process in order to further increase computational efficiency.

Alternative embodiments may be envisaged, which nevertheless fall within the scope of the following claims.

1. A method of learning natural language word associations using a neural network architecture, comprising processor implemented steps of:
storing data defining a word dictionary comprising words identified from training data consisting a plurality of sequences of associated words;
selecting a predefined number of data samples from the training data, the selected data samples defining positive examples of word associations;
generating a predefined number of negative samples for each selected data sample, the negative samples defining negative examples of word associations, wherein the number of negative samples generated for each data sample is a statistically small proportion of the number of words in the word dictionary; and
training a neural language model using said data samples and said generated negative samples.

2. The method of claim 1, wherein the negative samples for each selected data sample are generated by replacing one or more words in the data sample with a respective one or more replacement words selected from the word dictionary.

3. The method of claim 2, wherein the one or more replacement words are pseudo-randomly selected from the word dictionary based on frequency of occurrence of words in the training data.

4. The method of claim 1, wherein the number of negative samples generated for each data sample is between 1/10000 and 1/100000 of the number of words in the word dictionary.

5. The method of claim 1, wherein the neural language model is configured to output a word representation for an input word, representative of the association between the input word and other words in the word dictionary.

6. The method of claim 5, further comprising generating a word association matrix comprising a plurality of vectors, each vector defining a representation of a word in the word dictionary output by the trained neural language model.

7. The method of claim 6, further comprising using the word association matrix to resolve a word association query.

8. The method of claim 7, further comprising resolving the query without applying a word position-dependent weighting.

9. The method of claim 1, wherein the neural language model is trained without applying a word position-dependent weighting.

10. The method of claim 1, wherein the data samples each include a target word and a plurality of context words that are associated with the target word, and label data identifying the data sample as a positive example of word association.

11. The method of claim 10, wherein the negative samples each include a target word selected from the word dictionary and the plurality of context words from a data sample, and label data identifying the negative sample as a negative example of word association.

12. The method of claim 1, wherein the training samples and negative samples are fixed-length contexts.

13. The method of claim 1, wherein the neural language model is configured to receive a representation of the target word and representations of the plurality of context words of an input sample, and to output a probability value indicative of the likelihood that the target word is associated with the context words.

14. The method of claim 1, wherein the neural language model is further configured to receive a representation of the target word and representations of at least one context word of an input sample, and to output a probability value indicative of the likelihood that at least one context word is associated with the target word.

15. The method of claim 13, wherein training the neural language model comprises adjusting parameters based on a calculated error value derived from the output probability value and the label associated with the sample.

16. The method of claim 1, further comprising generating the word dictionary based on the training data, wherein the word dictionary includes calculated values of the frequency of occurrence of each word within the training data.

17. The method of claim 1, further comprising normalizing the training data.

18. The method of claim 1, wherein the training data comprises a plurality of sequences of associated words.

19. A method of predicting a word association between words in a word dictionary, comprising processor implemented steps of:
storing data defining a word association matrix including a plurality of vectors, each vector defining a representation of a word derived from a trained neural language model;
receiving a plurality of query words;
retrieving the associated representations of the query words from the word association matrix;
calculating a candidate representation based on the retrieved representations; and
determining at least one word in the word dictionary that matches the candidate representation, wherein the determination is made based on the word association matrix and without applying a word position-dependent weighting.

20. The method of claim 19, wherein the candidate representation is calculated as the average representation of the retrieved representations.

21. The method of claim 19, wherein calculating the representation comprises subtracting one or more retrieved representations from one or more other retrieved representations.

22. The method of claim 19, further comprising excluding one or more query words from the word dictionary before calculating the candidate representation.

23. The method of claim 19, wherein the trained neural language model is configured to output a word representation for an input word, representative of the association between the input word and other words in the word dictionary.

24. The method of claim 23, further comprising generating the word association matrix from representations of words in the word dictionary output by the trained neural language model.

25. The method of claim 19, further comprising training the neural language model according to claim 1.

26. The method of claim 25, wherein the training samples each include a target word and a plurality of context words that are associated with the target word, and label data identifying the sample as a positive example of word association.

27. The method of claim 26, wherein the negative samples each include a target word and a plurality of context words that are selected from the word dictionary, and label data identifying the sample as a negative example of word association.

28. The method of claim 27, wherein the data samples and negative samples have fixed-length contexts.

29. The method of claim 27, wherein the negative samples are pseudo-randomly selected based on frequency of occurrence of words in the training data.

30. The method of claim 29, further comprising receiving a representation of the target word and representations of the plurality of context words of an input sample, and outputting a probability value indicative of the likelihood that the target word is associated with the context words.

31. The method of claim 29, further comprising receiving a representation of the target word and representations of at least one context word of an input sample, and outputting a probability value indicative of the likelihood that at least one context word is associated with the target word.

32. The method of claim 30, further comprising training the neural language model by adjusting parameters based on a calculated error value derived from the output probability value and the label associated with the sample.

33. The method of claim 25, further comprising generating the word dictionary based on training data, wherein the word dictionary includes calculated values of the frequency of occurrence of each word within the training data.

34. The method of claim 25, further comprising normalizing the training data.

35. The method of claim 19, wherein the query is an analogy-based word similarity query.

36. A system for learning natural language word associations using a neural network architecture, comprising one or more processors configured to:
store data defining a word dictionary comprising words identified from training data consisting of a plurality of sequences of associated words;
select a predefined number of data samples from the training data, the selected data samples defining positive examples of word associations;
generate a predefined number of negative samples for each selected data sample, the negative samples defining negative examples of word associations, wherein the number of negative samples generated for each data sample is a statistically small proportion of the number of wherein the number of negative samples generated for each data sample is a statistically small proportion of the number of words in the word dictionary; and
train a neural language model using said data samples and said generated negative samples.

37. A data processing system for resolving a word similarity query, comprising one or more processors configured to:
store data defining a word association matrix including a plurality of vectors, each vector defining a representation of a word derived from a trained neural language model;
receive a plurality of query words;
retrieve the associated representations of the query words from the word association matrix;
calculate a candidate representation based on the retrieved representations; and
determine at least one word that matches the candidate representation, wherein the determination is made based on the word association matrix and without applying a word position-dependent weighting.

38. A non-transitive storage medium comprising machine readable instructions stored thereon for causing a computer system to perform a method in accordance with claim 1.

39. The method of claim 14, wherein training the neural language model comprises adjusting parameters based on a calculated error value derived from the output probability value and the label associated with the sample.

40. The method of claim 31, further comprising training the neural language model by adjusting parameters based on a calculated error value derived from the output probability value and the label associated with the sample.

41. A non-transitive storage medium comprising machine readable instructions stored thereon for causing a computer system to perform a method in accordance with claim 19.
